(19) United States
(12) Patent Application Publication
(10) Pub. No.: US 2014/0100681 A1
(43) Pub. Date: Apr. 10, 2014

(54) SYSTEM AND METHOD FOR AUDIO FILE CONVERSION

(71) Applicant: Toshiba Samsung Storage Technology Korea Corporation, Suwon-si (KR)

(72) Inventors: Soon Gyu JEONG, Suwon-si (KR); Young Woo LEE, Suwon-si (KR)

(21) Appl. No.: 14/036,060

(22) Filed: Sep. 25, 2013

(30) Foreign Application Priority Data
Oct. 5, 2012 (KR) 10-2012-0110724

(51) Int. Cl. G06F 3/16

(52) U.S. Cl. CPC G06F 3/162
USPC 700/94

(57) ABSTRACT

Provided are an apparatus and method for converting an audio track. The apparatus includes an audio track converter to convert an audio track included in a computer-readable medium into an audio file playable in a terminal, and a file sharer to share the converted audio file with the terminal. Accordingly, the audio apparatus enables an audio track stored on a computer-readable medium to be played by a terminal that does not support a format of the audio track stored on the computer-readable medium.

### CROSS-REFERENCE TO RELATED APPLICATION

This application claims the benefit under 35 USC 119(a) of Korean Patent Application No. 10-2012-0110724, filed on Oct. 5, 2012, in the Korean Intellectual Property Office, the entire disclosure of which is incorporated herein by reference for all purposes.

### BACKGROUND

1. Field

The following description relates to a system and method for an audio file conversion, and more particularly, to a system that reads a readable-medium in which an audio track is recorded and which converts the audio track to an audio file available for playing by a terminal.

2. Description of Related Art

A mobile terminal, for example, a smart phone or a tablet, may play a music file generated via a generally known codec. However, the mobile terminal is not able to immediately play a file recorded in an optical disc inserted into an optical disc drive (ODD) because the file recorded in the optical disc is in the form of an audio track. For example, the form of the audio track may be a compact disc-digital audio (CD-DA). In this case, the mobile terminal is not able to play the audio track in the form of the CD-DA.

Accordingly, there is a desire for a scheme of playing an audio track recorded in an optical disc more easily in a terminal that does not support a CD-DA.

### SUMMARY

In an aspect, there is provided an audio apparatus, including an audio tack converter configured to convert an audio track from a computer-readable medium into an audio file playable by a terminal, and a file sharer configured to share the converted audio file with the terminal.

The audio track converter may be configured to convert an audio track stored in the computer-readable medium to a virtual music file, using a file system in a user space.

The audio track converter may be configured to add a header associated with a music file to the audio track using the file system to convert the audio track to the virtual music file.

The file sharer may be configured to share the audio file with the terminal using a network protocol comprising at least one of a digital living network alliance (DLNA), Samba, a web distributed authoring and versioning (WebDAV), a file transfer protocol (FTP), and a digital audio access protocol (DAAP).

The terminal may be configured to connect to the file sharer using the network protocol, and play the audio file using a music playback program.

The file sharer may be configured to perform ripping of the audio file by copying the audio file to a local storage space of a terminal.

The file sharer may be configured to encode the audio file using a codec comprising at least one of a moving picture experts group (MPEG) audio layer-3 (MP3), an Ogg Vorbis (Ogg), a Windows Media Audio (WMA), an MPEG-4 audio (M4A), and an advanced audio coding (AAC).

The audio track converter may be configured to convert the audio file of the computer-readable medium from a compact disc digital audio (CD-DA) format into a waveform audio (WAV) format.

In an aspect, there is provided an audio apparatus, including an audio track converter configured to convert an audio track from a computer-readable medium into an audio file playable by a terminal, and a file player configured to play the converted audio file through a webpage, in response to a request received from a terminal to play the audio track.

The audio track converter may be configured to convert the audio track stored in the computer-readable medium to a virtual audio file, using a file system in a user space.

The audio track converter may be configured to add a header associated with a music file to the audio track.

The terminal may be configured to select a file list of audio tracks displayed on the webpage, and play an audio file through the webpage.

In an aspect, there is provided a method of processing an audio file, the method including converting an audio track from a computer-readable medium into an audio file playable by a terminal, and sharing the converted audio file with the terminal.

The converting of the audio track to the audio file may comprise converting the audio track stored in the computer-readable medium into a virtual music file using a file system in a user space.

The converting of the audio track to the audio file may comprise adding a header associated with a music file to the audio track, and converting the audio track to a virtual audio file, using the file system.

The sharing of the converted audio file with the terminal may comprise sharing an audio file with a terminal using a network protocol comprising at least one of a digital living network alliance (DLNA), Samba, a web distributed authoring and versioning (WebDAV), a file transfer protocol (FTP), and a digital audio access protocol (DAAP).

The terminal may be configured to connect to the file sharer using the network protocol, and play an audio file using a music playback program while connected to the file sharer.

The sharing of the converted audio file with the terminal may comprise copying the audio file to a local storage space of the terminal.

The sharing of the converted audio file with the terminal may comprise encoding the audio file using a codec comprising at least one of a moving picture experts group (MPEG) audio layer-3 (MP3), an Ogg Vorbis (Ogg), a Windows Media Audio (WMA), an MPEG-4 audio (M4A), and an advanced audio coding (AAC).

In an aspect, there is provided a method of processing an audio file, the method including converting an audio track from a computer-readable medium into an audio file playable by a terminal, and playing the converted audio file through a webpage, in response to a request received from the terminal to play the audio track.

The converting of the audio track to the audio file may comprise adding a header associated with a music file to the audio track, and converting to the audio file using a file system in a user space.

Other features and aspects will be apparent from the following detailed description, the drawings, and the claims.

### BRIEF DESCRIPTION OF THE DRAWINGS

FIG. 1 is a diagram illustrating an example of an audio system.

FIG. 2 is a diagram illustrating another example of an audio system.

FIG. 3 is a diagram illustrating an example of a converted audio file.

FIG. 4 is a diagram illustrating an example of an audio system.

FIG. 5 is a diagram illustrating an example of converting an audio track recorded in an inserted readable-medium to an audio file playable in a terminal.

FIG. 6 is a diagram illustrating an example of sharing a converted audio file playable in a terminal.

FIG. 7 is a diagram illustrating an example of transmitting an audio file converted in an audio system to a web server provider, and playing the audio file in response to a request received from a terminal.

FIG. 8 is another diagram illustrating an example of an audio system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

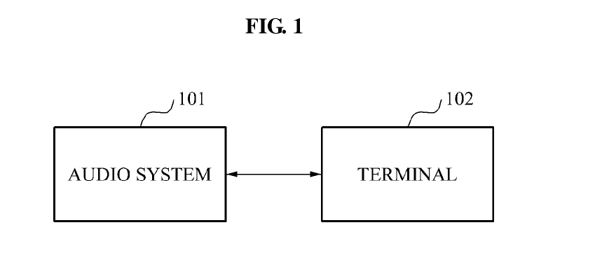

FIG. 1 illustrates an example of an audio system 101.

Referring to FIG. 1, the audio system 101 and a terminal 102 may be implemented in separate forms. For example, the audio system 101 may be disposed outside of the terminal 102, and may have inserted therein a readable medium in which an audio track is recorded. The audio system 101 may read an audio track from a readable medium optical disc, for example, a compact disc-read only memory (CD-ROM), a digital versatile disc (DVD)-ROM, a Blu-Ray, and the like.

The audio system 101 may include an ODD. The terminal 102 may include all types of terminals, for example, a personal computer (PC), a laptop, a television (TV), an audio player, a mobile terminal such as a mobile phone, a tablet PC, a personal digital assistant (PDA), and the like. It should be appreciated that the terminal 102 may be connected to the audio system 101 via any available form of wired communication or wireless communication.

As an example, when a medium in which an audio track is recorded is inserted into the audio system 101, the audio system 101 may identify the audio track recorded in the medium. According to various aspects, the audio system 101 may convert the audio track identified from the medium to a virtual audio file that is playable by the terminal 102. The audio system 101 may share the converted audio file with the terminal 102. Accordingly, the terminal 102 may play the audio track stored in the readable medium via the audio file converted by the audio system 101.

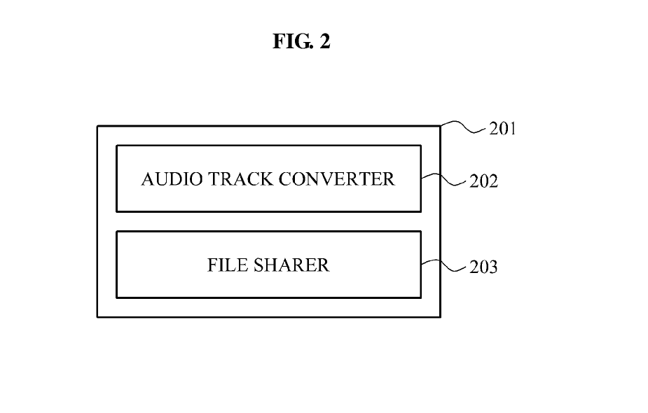

FIG. 2 illustrates another example of an audio system 202.

Referring to FIG. 2, the audio system 201 includes an audio track converter 202 and a file sharer 203. The audio track converter 202 may convert an audio track recorded in a readable medium into a virtual audio file. For example, the audio track converter 202 may convert an audio track that is in the form of a compact disc-digital audio (CD-DA) that is recorded in a readable medium, such as a CD-ROM, a DVD-ROM, and a Blu-Ray, and the like.

The audio track converter 202 may convert the audio track recorded in the readable medium to a virtual audio file that is playable by the terminal 102. For example, the audio track converter 202 may convert the audio track recorded in the readable medium to an audio file having a form of a waveform audio (wave) or (way) file that is capable of being played by the terminal 102.

To this end, the audio track converter 202 may add a file header indicating a wave file to the audio track recorded in the readable medium, and convert the audio track to a virtual audio file. As an example, the audio track converter 202 may add a header indicating a wave file to the audio track, and convert the audio track to the virtual audio file in a case in which the audio track includes audio data representing two channels as linear pulse code modulation (PCM) data.

According to various aspects, the audio track may be converted to the virtual audio file by adding the header of the wave file, such that a format of the audio track may be identified as a wave file. In this example, the audio track converter 202 may convert the audio track to the audio file by adding the header indicating an audio file, without changing content of the audio track. For example, the audio track converter 202 may convert the audio track to the audio file, using a file system in a user space.

The file sharer 203 may share an audio file with the terminal 102 through a network protocol. For example, the network protocol may include at least one of a digital living network appliance (DLNA), Samba, Web Distributed Authoring and Versioning (WebDAV), a File Transfer Protocol (FTP), a Digital Audio Access Protocol (DAAP), and the like. It should be appreciated that the network protocol is not limited to the above examples, and may include all types of network protocols that enable data communication between the audio system 201 and the terminal 102. It should also be appreciated that the file sharer 203 may share data with all types of apparatuses that enable data communication and a web server, using the network protocol.

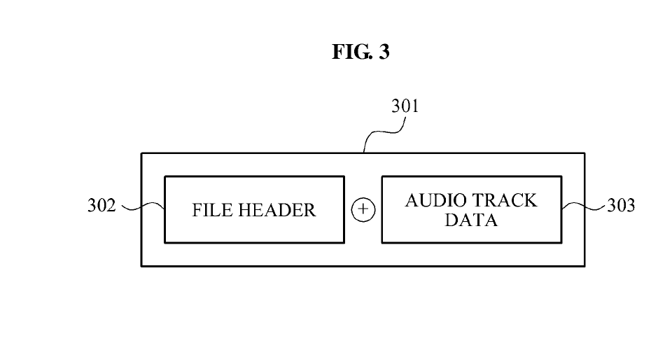

FIG. 3 illustrates an example of a converted audio file.

Referring to FIG. 3, the audio file 301 includes a file header 302 and audio track data 303. The audio track recorded in the optical disc may be configured by the audio track data 303. According to various aspects, an audio system may add the file header 302 associated with the audio file 301 to the audio track, and convert a format of the audio track data 303 to the audio file 301.

For example, the audio system may add the file header 302 associated with a wave file to the audio track data 303, and convert the audio track data 303 to the audio file 301 in a case in which the audio track data 303 is 16 bits, 44,100 kilohertz (KHz) linear PCM data. When viewed externally, the audio track data 303 may be identified to be the audio file 301, for example, as a virtual wave file.

A terminal may play an audio track stored in a readable medium, by receiving the virtual wave file from the audio system and playing the virtual wave file, via various network protocols.

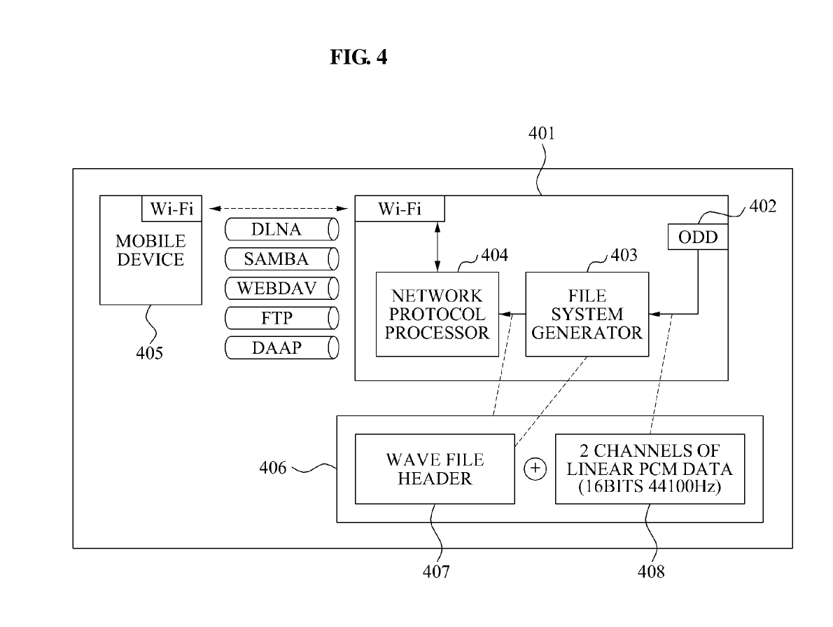

FIG. 4 illustrates another example of an audio system 401.

Referring to FIG. 4, the audio system 401 includes a file system generator 403 and a network protocol processor 404. The file system generator 403 may be the equivalent of the audio track converter 202 of FIG. 2. The network protocol processor 404 may be the equivalent of the file sharer 203 of FIG. 2. According to various aspects, the audio system 401 may be an apparatus which includes an ODD 402 for recording data to a readable medium, for example, a CD-ROM, a DVD-ROM, a Blu-Ray, and the like.

The audio system 401 and a terminal, for example, a mobile device 405, may be configured separately. The audio system 401 and the mobile device 405 may perform data communication with one another, using a network protocol.

The audio system 401 may transfer the audio track 408 recorded in the readable medium while the medium is inserted into the optical disc drive (ODD) 402, to the file system generator 403. As an example, the audio track 408 may be configured by two channels of linear PCM data. In this example, the audio track may be represented in 16 bits of 44,100 Hz data.

The file system generator 403 may add a file header 407 associated with a wave file to the audio track 408. For example, the file system generator 403 may add the file header 407 associated with the audio file 406 to the audio track 408, and convert the audio track 408 to the virtual audio file 406.

The network protocol processor 404 may share the virtual audio file converted via the file system generator 403, using the network protocol. For example, the network protocol processor 404 may share the audio file 406 with the mobile device 405, via at least one network protocol.

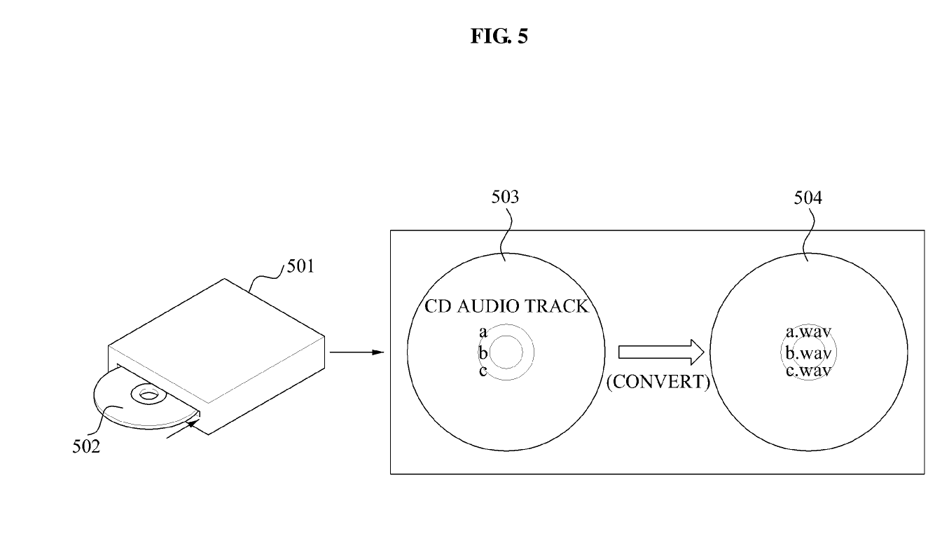

FIG. 5 illustrates an example of converting an audio track recorded in an inserted readable-medium into an audio file playable in a terminal.

Referring to FIG. 5, audio system 501 may include an ODD for recording data in readable media 502 and 503, for example, a CD-ROM, a DVD-ROM, a Blu-Ray disc, and the like. In this example, the audio system 501 is external, and operates independently outside of a terminal rather than being disposed inside the terminal.

The audio system 501 may identify the inserted readable media 502 and 503. As an example, readable medium 503 may include an audio track associated with music data. Here, the audio system 501 may convert an audio track associated with music data to a virtual audio file 504 playable in the terminal. The audio system 501 may add a file header of a virtual audio file to the audio track, and convert the audio track.

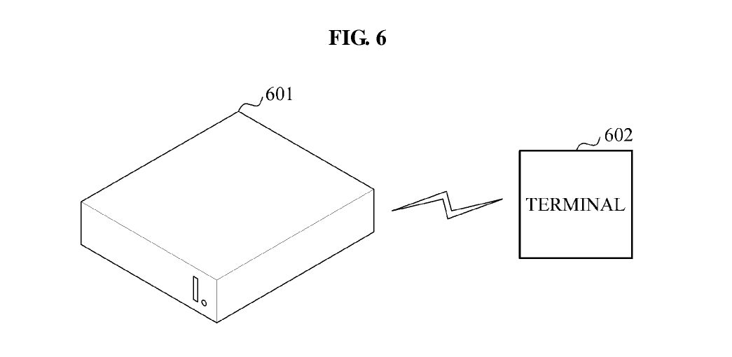

FIG. 6 illustrates an example of a process of sharing a converted audio file playable in a terminal 602.

Referring to FIG. 6, audio system 601 is configured separately from the terminal 602. The audio system 601 may share a virtual audio file with the terminal 602, using a network protocol identical to the terminal 602.

The terminal 602 may connect to the file sharer 203 of the audio system 601 in order to share the virtual audio file. For example, the terminal 602 may download the audio file shared via the file sharer 203 to play the audio file. As another example, the terminal 602 may play an audio file without a local storage for storing an audio file through directly playing the audio file by the audio system 601, without downloading the audio file from the file sharer 203.

As another example, the terminal 602 may copy the virtual audio file stored in the file sharer 203 to the local storage of the terminal 602 through connecting to the file sharer 203. Here, an audio track in a CD-DA format recorded in a readable medium, for example, an optical disc, may be ripped in the terminal 602. According to various aspects, the file sharer 203 may encode the audio file selected by the terminal 602, using a codec including at least one of an MPEG audio layer-3, an Ogg Vorbis (Ogg), a Windows media audio (WMA), an MPEG-4 audio (M4A), and an advanced audio coding (AAC). Accordingly, a the terminal 602 may receive an audio file to play in the terminal 602, and may play the audio track recorded in the readable medium in the terminal 602 without an additional program.

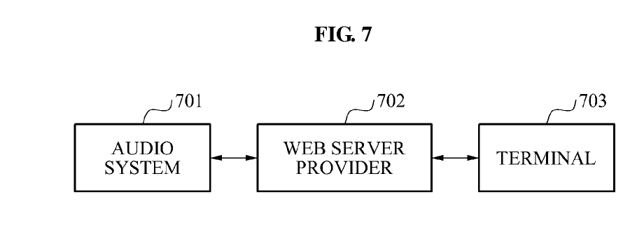

FIG. 7 illustrates an example of transmitting an audio file converted in an audio system 701 to a web server provider 702, and playing the audio file in response to a request for playing the audio file received from a terminal 703.

Referring to FIG. 7, the audio system 701, the web server provider 702, and the terminal 703 are configured separately. The audio system 701 may share an audio track with the web server provider 702 via a network protocol. According to various aspects, the audio system 701 may convert an audio track stored in a readable medium to a virtual audio file, using a file system in a user space. For example, the audio system 701 may add a file header associated with music to an audio track stored in a readable medium, and convert the audio track to the virtual audio file.

The web server provider 702 may provide the terminal 703 with data associated with the converted virtual audio file, using a webpage. For example, the data associated with a virtual music file may include a file list of an audio track. The web server provider 702 may play an audio file corresponding to the file list of the audio track selected from the terminal 703 via the webpage.

According to various aspects, the terminal 703 may access the virtual audio file converted in the audio system 701 via the webpage provided by the web server provider 702. The terminal 703 may connect to the webpage provided by the web server provider 702, and play the virtual audio file converted from the audio track stored in the readable medium. Accordingly, the terminal 703 may be provided with the virtual audio file converted from the audio track, absent temporal or spatial limitations, by connecting to the webpage without connecting directly to the audio system 701. In FIG. 7, the web server provider 702 may be connected to the audio system 701 or may be included in the audio system 701.

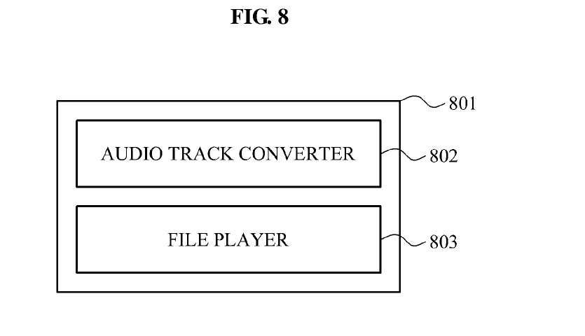

FIG. 8 illustrates another example of an audio system 801.

Referring to FIG. 8, the audio system 801 includes an audio track converter 802 and a file player 803. The audio track converter 802 may convert an audio track included in a readable medium inserted into the audio system 801 to an audio file. The audio track converter 802 may add a file header associated with music to the audio track stored in the readable medium, and convert the audio track to a virtual audio file.

The file player 803 may play the converted audio file in response to a request for playing the audio track selected from the terminal. For example, the terminal may play the virtual audio file converted from the audio track, via s webpage provided by the audio system.

According to various aspects, it is possible to identify a readable medium in which an audio track is recorded, and convert the readable medium to an audio file playable in a terminal. For example, it is possible to add a header associated with a music file to an audio track, and convert the audio track to a virtual audio file.

According to various aspects, it is possible to share a virtual audio file with a terminal or a web server, using a network protocol. Accordingly, it is possible for a terminal to play the converted audio file via a webpage, in response to a request for playing an audio track received from the terminal to a web server.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An audio apparatus, comprising:
an audio tack converter configured to convert an audio track from a computer-readable medium into an audio file playable by a terminal; and
a file sharer configured to share the converted audio file with the terminal.

2. The audio apparatus of claim 1, wherein the audio track converter is configured to convert an audio track stored in the computer-readable medium to a virtual music file, using a file system in a user space.

3. The audio apparatus of claim 2, wherein the audio track converter is configured to add a header associated with a music file to the audio track using the file system to convert the audio track to the virtual music file.

4. The audio apparatus of claim 1, wherein the file sharer is configured to share the audio file with the terminal using a network protocol comprising at least one of a digital living network alliance (DLNA), Samba, a web distributed authoring and versioning (WebDAV), a file transfer protocol (FTP), and a digital audio access protocol (DAAP).

5. The audio apparatus of claim 1, wherein the terminal is configured to connect to the file sharer using the network protocol, and play the audio file using a music playback program.

6. The audio apparatus of claim 1, wherein the file sharer is configured to perform ripping of the audio file by copying the audio file to a local storage space of a terminal.

7. The audio apparatus of claim 1, wherein the file sharer is configured to encode the audio file using a codec comprising at least one of a moving picture experts group (MPEG) audio layer-3 (MP3), an Ogg Vorbis (Ogg), a Windows Media Audio (WMA), an MPEG-4 audio (M4A), and an advanced audio coding (AAC).

8. The audio apparatus of claim 1, wherein the audio track converter is configured to convert the audio file of the computer-readable medium from a compact disc digital audio (CD-DA) format into a waveform audio (WAV) format.

9. An audio apparatus, comprising:
an audio track converter configured to convert an audio track from a computer-readable medium into an audio file playable by a terminal; and
a file player configured to play the converted audio file through a webpage, in response to a request received from a terminal to play the audio track.

10. The audio apparatus of claim 9, wherein the audio track converter is configured to convert the audio track stored in the computer-readable medium to a virtual audio file, using a file system in a user space.

11. The audio apparatus of claim 10, wherein the audio track converter is configured to add a header associated with a music file to the audio track.

12. The audio apparatus of claim 9, wherein the terminal is configured to select a file list of audio tracks displayed on the webpage, and play an audio file through the webpage.

13. A method of processing an audio file, the method comprising:
converting an audio track from a computer-readable medium into an audio file playable by a terminal; and
sharing the converted audio file with the terminal.

14. The method of claim 13, wherein the converting of the audio track to the audio file comprises:
converting the audio track stored in the computer-readable medium into a virtual music file using a file system in a user space.

15. The method of claim 13, wherein the converting of the audio track to the audio file comprises:
adding a header associated with a music file to the audio track, and converting the audio track to a virtual audio file, using the file system.

16. The method of claim 13, wherein the sharing of the converted audio file with the terminal comprises:
sharing an audio file with a terminal using a network protocol comprising at least one of a digital living network alliance (DLNA), Samba, a web distributed authoring and versioning (WebDAV), a file transfer protocol (FTP), and a digital audio access protocol (DAAP).

17. The method of claim 13, wherein the terminal is configured to connect to the file sharer using the network protocol, and play an audio file using a music playback program while connected to the file sharer.

18. The method of claim 13, wherein the sharing of the converted audio file with the terminal comprises:
copying the audio file to a local storage space of the terminal.

19. The method of claim 13, wherein the sharing of the converted audio file with the terminal comprises:
encoding the audio file using a codec comprising at least one of a moving picture experts group (MPEG) audio layer-3 (MP3), an Ogg Vorbis (Ogg), a Windows Media Audio (WMA), an MPEG-4 audio (M4A), and an advanced audio coding (AAC).

20. A method of processing an audio file, the method comprising:
converting an audio track from a computer-readable medium into an audio file playable by a terminal; and
playing the converted audio file through a webpage, in response to a request received from the terminal to play the audio track.

21. The method of claim 20, wherein the converting of the audio track to the audio file comprises:
adding a header associated with a music file to the audio track, and converting to the audio file using a file system in a user space.
